(19) United States
(12) Patent Application Publication
(10) Pub. No.: US 2006/0235558 A1
(43) Pub. Date: Oct. 19, 2006

(54) Method of scavenging intermediate formed by reaction of oxidoreductase with substrate

(75) Inventor: Osamu Tanaka, Tosu-shi, Saga (JP)

Correspondence Address: Smith Gambrell & Russell, Suite 800, 1850 M Street N W, Washington, DC, 20036, US

(73) Assignee: TOKYO EECTRON LIMITED, TOKYO (JP)

(21) Appl. No.: 10/541,379

(22) PCT Filed: Mar. 29, 2005
(86) PCT No.: PCT/JP05/05797

§ 371 Date: Jul. 6, 2005

(30) Foreign Application Priority Data
Aug. 28, 2002 (JP) 2002-248909

(51) Int. Cl. G06F 19/00

(52) U.S. Cl. 700/108; 700/80; 702/185

(57) ABSTRACT

A process system 1 comprises a process apparatus 10 which performs a predetermined process on a wafer W, a plurality of detection means which detect statuses in the process apparatus 10, an abnormality detection section 15 which detects an abnormality in detection information from the plurality of detection means, an alarm generation section 16 which generates an alarm when the abnormality detection section 15 detects an abnormality, an information storage section 17 which stores the detection information from the detection means in the process apparatus 10 and alarm information as a process history of the process apparatus 10, an alarm-related information acquisition section 18 which selectively acquires information relating to an alarm selected from the information storage section 17, and a display section 21 which displays alarm-related information acquired by the alarm-related information acquisition section 18.

### FIELD OF THE INVENTION

The present invention relates to a process system and a process method, which include a process apparatus that performs a predetermined process on an object to be processed at the time of fabricating, for example, a semiconductor device, a computer readable storage medium, and a computer program.

### DESCRIPTION OF THE RELATED ART

In a fabrication process for semiconductor devices, for example, various processes are performed on a semiconductor wafer (hereinafter simply written as wafer), for which various kinds of process apparatuses are used. There is, for example, a cleaning apparatus which performs soaking and processing a wafer in a single process bath or plural process baths retaining a process liquid thereafter drying, as such a process apparatus.

Such a cleaning apparatus is provided with a control system that receives various kinds of detection data from a temperature sensor which detects the temperature of a process liquid to be supplied to a substrate, a concentration sensor which detects the concentration of the process liquid, a position sensor which detects the position of the process liquid in the bath, and the like to detect the status of the cleaning apparatus, and controls the cleaning apparatus based on various kinds of detection data. When the detected value of a sensor exceeds a preset allowance value while the apparatus is in operation, the control system generates an alarm, considering that there is a possible occurrence of a failure in the apparatus.

In a wafer process, a plurality of process apparatuses are laid out to construct a process system, but the size of such a process system recently is becoming larger, so that there are ever increasing demands for integrated control of multiple process apparatuses.

Accordingly, individual process apparatuses are provided with control units that are connected to a host computer, which performs tracking of individual process apparatuses, stores process data, received from the process apparatuses, as a history, displays the contents thereof on a display device, and performs correction of various parameters, abnormality detection, and so forth of the process apparatuses, through exchange of various kinds of data with the control units of the process apparatuses.

Patent Literature 1 discloses that because process data to be stored is restrictive and it is difficult to find an abnormality in, and degrading of the characteristic of, a process apparatus early in an integrated control system using such a host computer, a controller, which collects all process data generated by the control units of individual process apparatuses, analyzes the collected process data and outputs the analysis results, is provided in addition to the host computer. This can increase process data to be grasped and can ensure early detection of a change in the status of each process apparatus with time.

When an alarm is generated in such a system, however, brief information on which part an alarm is generated is acquired, but detailed information or so on the apparatus side which is the cause for the alarm generation is not acquired, so that it is difficult to specify the location of the cause for the alarm generation in detail. Therefore, it takes a long time for an operator to find the location of the cause for alarm generation and restore the process apparatus.
[Patent Literature 1]
   Unexamined Japanese Patent Application KOKAI Publication No. H11-16797

### DISCLOSURE OF INVENTION

It is an object of the present invention to provide a process system and a process method, which can easily specify the location of the cause for alarm generation, and a computer readable storage medium and a computer program, which perform such control.

According to the first aspect of the invention, there is provided a process system comprising a process apparatus which performs a predetermined process on an object to be processed; a plurality of detection means which detect statuses in the process apparatus; an abnormality detection section which detects an abnormality in detection information from the plurality of detection means; an alarm generation section which generates an alarm when the abnormality detection section detects an abnormality; an information storage section which stores the detection information from the detection means and alarm information as a process history of the process apparatus; an alarm-related information acquisition section which acquires information relating to an alarm selected from generated alarms from the information storage section; and a display section which displays alarm-related information acquired by the alarm-related information acquisition section.

According to the second aspect of the invention, there is provided a process system comprising a process apparatus which performs a predetermined process on an object to be processed; a plurality of detection means which detect statuses in the process apparatus; an abnormality detection section which detects an abnormality in detection information from the plurality of detection means; an alarm generation section which generates an alarm when the abnormality detection section detects an abnormality; an information storage section which stores the detection information from the detection means and alarm information as a process history of the process apparatus and prestores an alarm table describing brief information according to individual alarms and linkable to the process history; an alarm-related information acquisition section which selects brief information on an alarm selected from the alarm table in the information storage section and acquires, as link information, sequential information leading to generation of the selected alarm from information stored as the process history in the information storage section; and a display section which displays alarm-related information acquired by the alarm-related information acquisition section.

According to the third aspect of the invention, there is provided a process system comprising a plurality of process apparatuses which perform a predetermined process on an object to be processed; an apparatus control unit which controls the plurality of process apparatuses based on information to be detected in the process apparatuses, detects an abnormality when the information to be detected in the process apparatuses is off a predetermined range, and generates an alarm when the abnormality detection section detects an abnormality; and a control apparatus which receives all or nearly all process information from the process apparatuses, and controls the process apparatuses based on the process information, and which includes an information storage section which stores the process information and alarm information received from the process apparatuses as process histories of the process apparatuses, an alarm-related information acquisition section which acquires information relating to an alarm selected from generated alarms from the information storage section, and a display section which displays alarm-related information acquired by the alarm-related information acquisition section.

According to the fourth aspect of the invention, there is provided a process system comprising a plurality of process apparatuses which perform a predetermined process on an object to be processed; an apparatus control unit which controls the plurality of process apparatuses based on information to be detected in the process apparatuses, detects an abnormality when the information to be detected in the process apparatuses is off a predetermined range, and generates an alarm when the abnormality detection section detects an abnormality; and a control apparatus which receives all or nearly all process information from the process apparatuses, and controls the process apparatuses based on the process information, and which includes an information storage section which stores the process information and alarm information received from the process apparatuses as process histories of the process apparatuses, and prestores an alarm table describing brief information according to individual alarms and linkable to the process history, an alarm-related information acquisition section which selects brief information on an alarm selected from the alarm table in the information storage section and acquires, as link information, sequential information leading to generation of the selected alarm from information stored as the process histories in the information storage section, and a display section which displays alarm-related information acquired by the alarm-related information acquisition section.

According to the fifth aspect of the invention, there is provided a process method comprising: storing detection information from a plurality of detection means provided in a process apparatus, which performs a predetermined process on an object to be processed, and information on alarms to be generated when detecting an abnormality in the detection information from the plurality of detection means, as a process history in an information storage section; acquiring information relating to an alarm selected from the generated alarms from the information storage section; and displaying alarm-related information acquired.

According to the sixth aspect of the invention, there is provided a process method comprising: storing detection information from a plurality of detection means provided in a process apparatus, which performs a predetermined process on an object to be processed, and information on alarms to be generated when detecting an abnormality in the detection information from the plurality of detection means, as a process history in an information storage section; prestoring an alarm table describing brief information according to individual alarms and linkable to the process history; selecting brief information on an alarm selected from the alarm table in the information storage section; acquiring, as link information, sequential information leading to generation of the selected alarm from information stored as the process history in the information storage section; and displaying information selected from the alarm table and the acquired sequential information leading to generation of the selected alarm.

According to the seventh aspect of the invention, there is provided a computer readable storage medium containing software that allows a computer to perform control in a way which comprises storing detection information from a plurality of detection means provided in a process apparatus, which performs a predetermined process on an object to be processed, and information on alarms to be generated when detecting an abnormality in the detection information from the plurality of detection means, as a process history in an information storage section, acquiring information relating to an alarm selected from the generated alarms from the information storage section, and displaying alarm-related information acquired.

According to the eighth aspect of the invention, there is provided a computer readable storage medium containing software that allows a computer to perform control in a way which comprises storing detection information from a plurality of detection means provided in a process apparatus, which performs a predetermined process on an object to be processed, and information on alarms to be generated when detecting an abnormality in the detection information from the plurality of detection means, as a process history in an information storage section, prestoring an alarm table describing brief information according to individual alarms and linkable to the process history, selecting brief information on an alarm selected from the alarm table in the information storage section, acquiring, as link information, sequential information leading to generation of the selected alarm from information stored as the process history in the information storage section, and displaying information selected from the alarm table and the acquired sequential information leading to generation of the selected alarm.

According to the ninth aspect of the invention, there is provided a computer program containing software that allows a computer to perform control in a way which comprises storing detection information from a plurality of detection means provided in a process apparatus, which performs a predetermined process on an object to be processed, and information on alarms to be generated when detecting an abnormality in the detection information from the plurality of detection means, as a process history in an information storage section, acquiring information relating to an alarm selected from the generated alarms from the information storage section, and displaying alarm-related information acquired.

According to the tenth aspect of the invention, there is provided a computer program containing software that allows a computer to perform control in a way which comprises storing detection information from a plurality of detection means provided in a process apparatus, which performs a predetermined process on an object to be processed, and information on alarms to be generated when detecting an abnormality in the detection information from the plurality of detection means, as a process history in an information storage section, prestoring an alarm table describing brief information according to individual alarms and linkable to the process history, selecting brief information on an alarm selected from the alarm table in the information storage section, acquiring, as link information, sequential information leading to generation of the selected alarm from information stored as the process history in the information storage section, and displaying information selected from the alarm table and the acquired sequential information leading to generation of the selected alarm.

According to the invention, as process information from a process apparatus including detection information from detection means, and alarm information are stored in an information storage section as a process history of the process apparatus, information relating to an alarm selected from alarms generated is selectively acquired from the information storage section, and the information is displayed, it is possible to grasp information leading to generation of the alarm from the process history and easily grasp the location of the cause for the alarm generation. Particularly, a more detailed cause for the alarm generation can be grasped by grasping sequential information leading to generation of a predetermined alarm to the level of I/O data in detail, so that the location of the cause for the alarm generation can be specified more easily and reliably. It is therefore possible to quickly remove an abnormality at the location of the cause for the alarm generation, so that when an abnormality occurs in an process apparatus, the process apparatus can be restored in a short period of time and the down time of the process apparatus can be shortened.

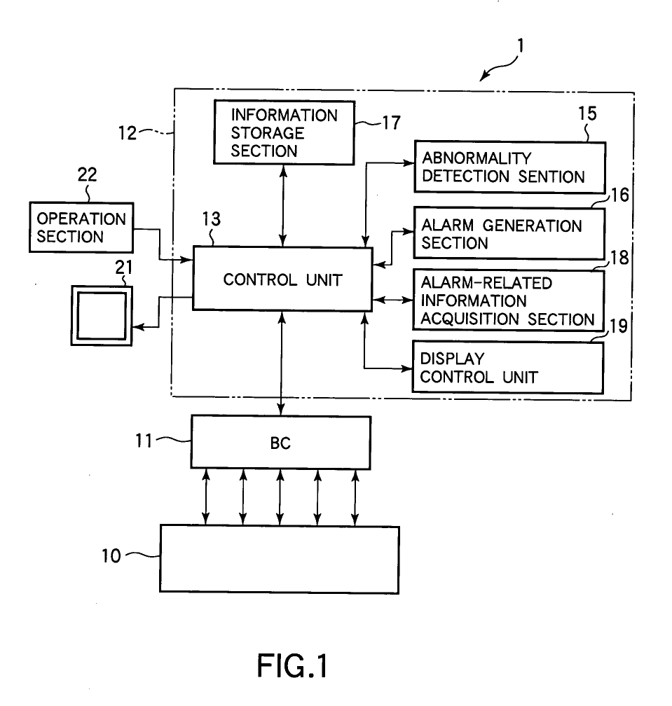

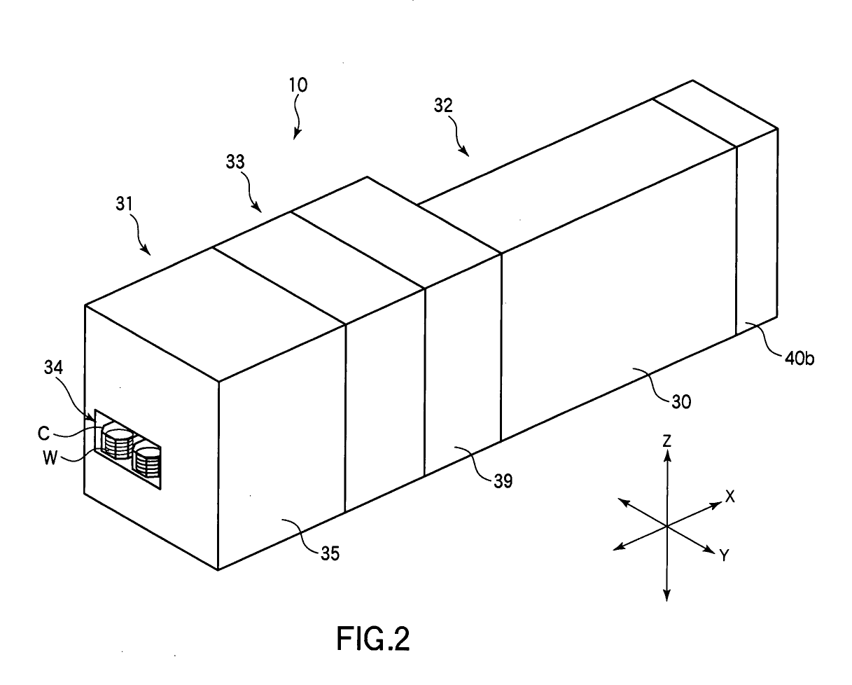

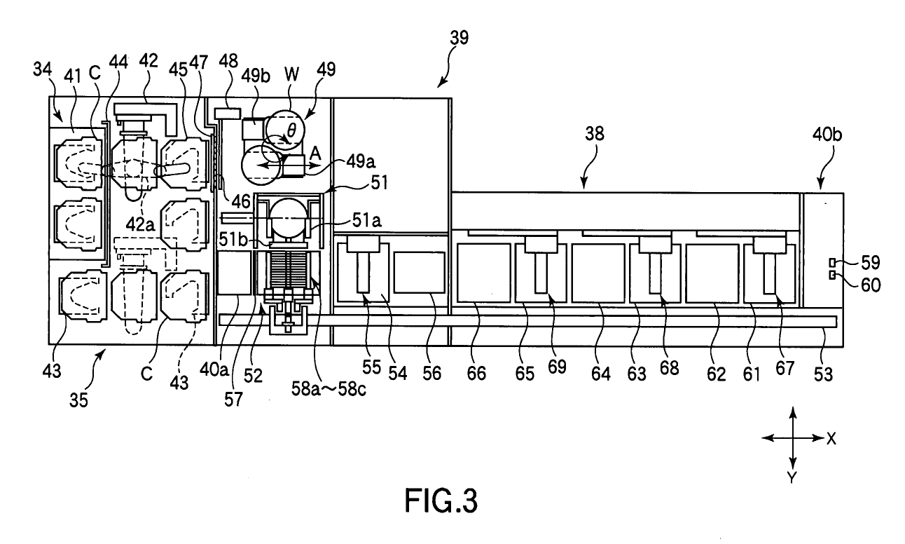

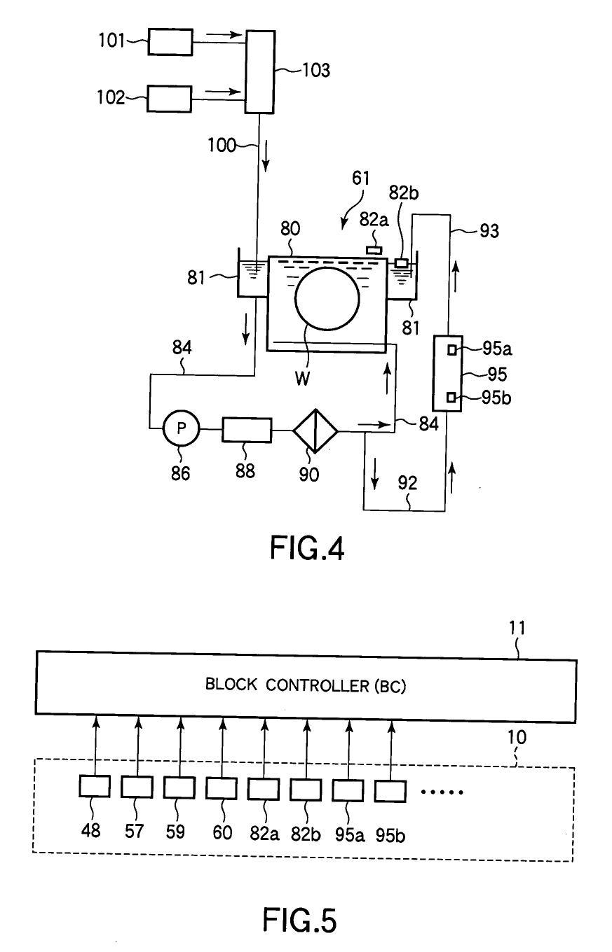

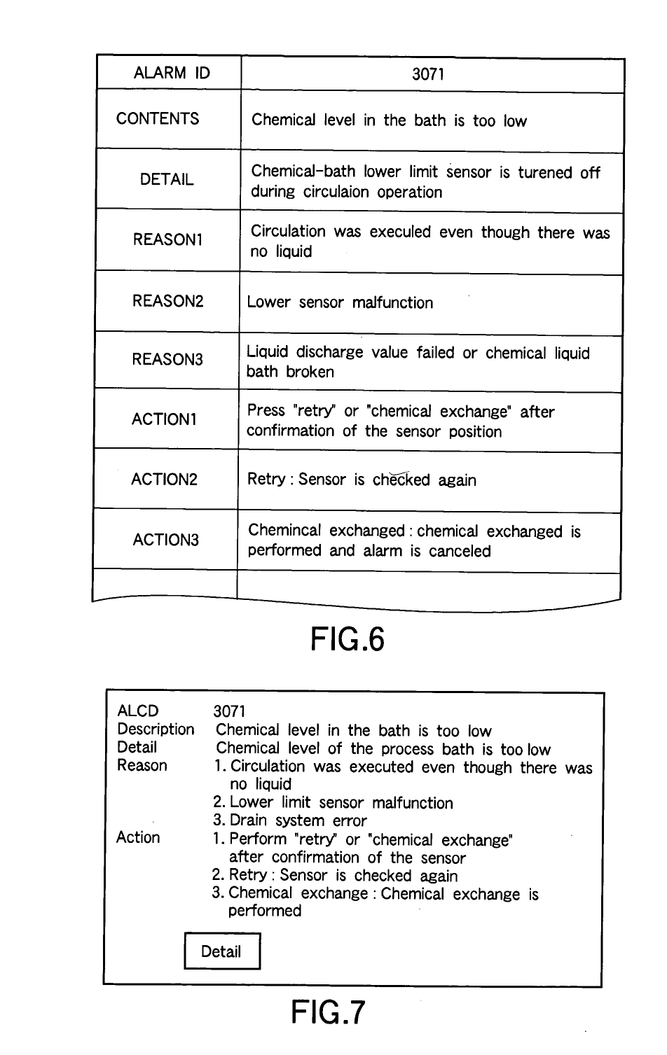

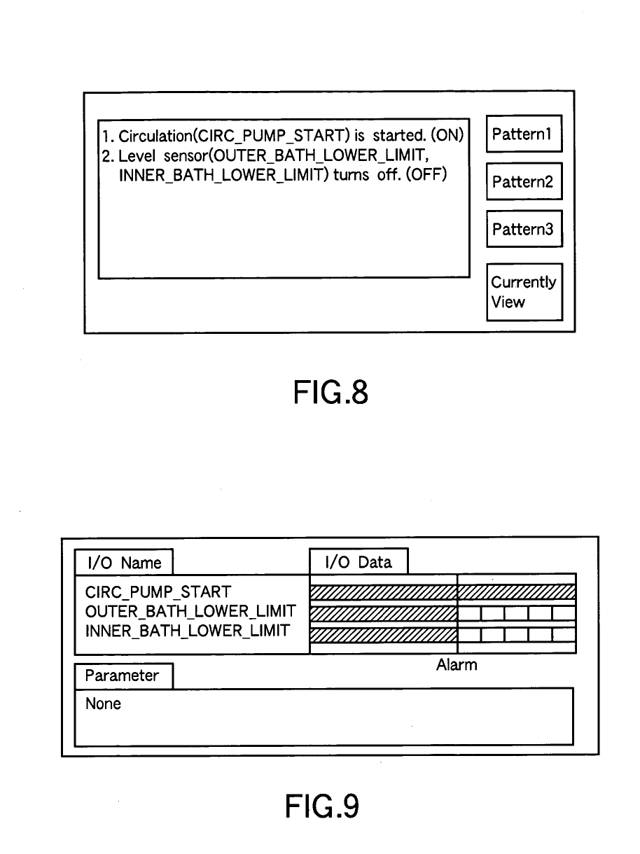

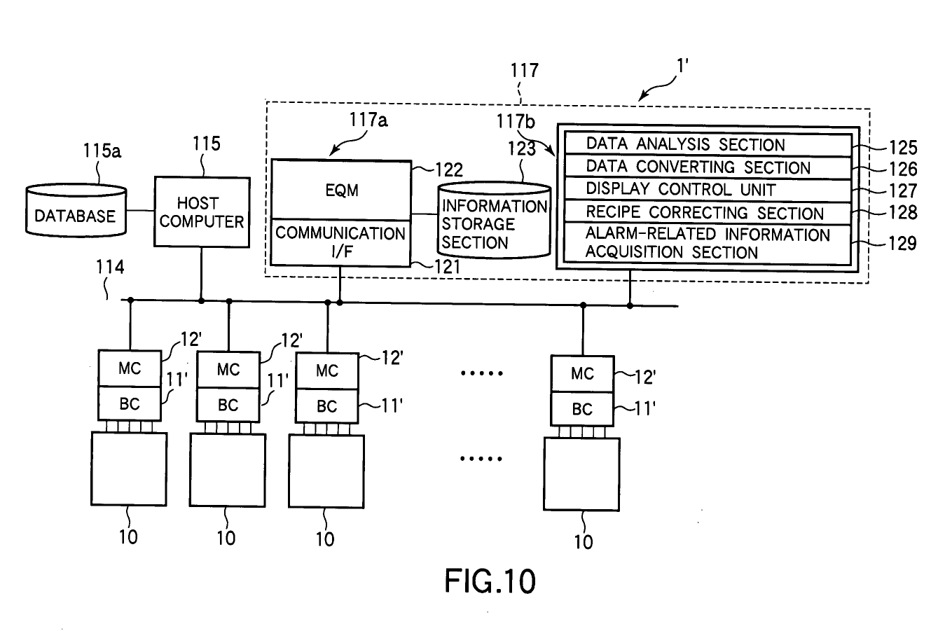

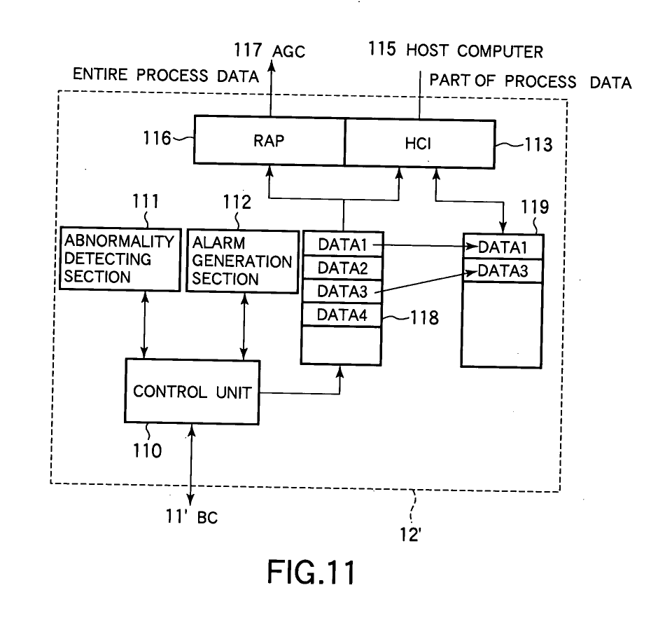

### BRIEF DESCRIPTION OF DRAWINGS

[FIG. 1] Block diagram showing the general structure of a process system according to one embodiment of the invention.

[FIG. 2] Perspective view showing one example of a process apparatus to be used in the process system according to one embodiment of the invention.

[FIG. 3] Plan view showing one example of the process apparatus to be used in the process system according to one embodiment of the invention.

[FIG. 4] Schematic diagram showing a first chemical bath and its piping system in the process apparatus to be used in the process system according to one embodiment of the invention.

[FIG. 5] Block diagram showing main detection means connected to a block controller (BC).

[FIG. 6] Diagram showing an example of the description in an alarm table.

[FIG. 7] Diagram showing one example of a monitor screen displaying an alarm.

[FIG. 8] Diagram showing one example of a monitor screen displaying sequential detailed information leading to alarm generation.

[FIG. 9] Diagram showing one example of a monitor screen displaying relating I/O address data around alarm generation.

[FIG. 10] Block diagram showing the general structure of a process system according to another embodiment of the invention.

[FIG. 11] Block diagram showing the schematic structure of a main controller (MC) in an process apparatus to be used in the process system in FIG. 10.

### BEST MODE FOR CARRYING OUT THE INVENTION

An embodiment of the invention will be described below referring to the accompanying drawings.

The following discusses a process system equipped with a process apparatus which cleans a wafer as a substrate by performing a liquid process thereon. FIG. 1 is a block diagram showing the general structure of the process system according to the embodiment.

This process system 1 has process apparatuses 10 which clean a wafer by performing a liquid process thereon, a block controller (BC) 11 as a low-rank control system, and a main controller (MC) 12 as a high-rank control system. As will be discussed later, each process apparatus 10 has a plurality of detection means which detects various process statuses, process information including detection information from the detection means is input to the block controller (BC) 11 and is sent to the main controller (MC) 12. A monitor 21 capable of displaying various screen and an operation section 22 are connected to the main controller (MC) 12.

As shown in FIG. 1, the main controller (MC) 12 has a control unit 13, which receives process information from the block controller (BC), sends a control signal to the block controller (BC), and processes the received process information, an abnormality detecting section 15, which analyzes process information received from the control unit 13 and detects an abnormality, an alarm generation section 16 which generates an alarm based on abnormality detection information from the abnormality detecting section 15, an information storage section 17 which stores process information received by the control unit 13 from the block controller (BC) 11, generation of an alarm, and other alarm information, an alarm-related information acquisition section 18 which selects information relating to each alarm, and a display control unit 19 which displays information selected from the process information and alarm information on the monitor 21.

The control unit 13, which comprises a general-purpose computer, performs predetermined control by a program for executing a predetermined process, i.e., a recipe. The recipe may be stored on a hard disk or in a semiconductor memory, or may be set stored in a portable memory medium, such as CD ROM or DVD, set at a predetermined position. Further, the recipe may be transferred from another apparatus via, for example, an exclusive circuit, as needed.

Control of the process apparatus 10 by the control unit 13 is carried out by outputting control signals to individual components of the process apparatus 10 based on signals or the like from the individual detection means, sent via the block controller (BC) 11, and process information input to the control unit 13 via the block controller (BC) 11 is stored in the information storage section 17 after being subjected to signal processing in the control unit 13. The control unit 13 sends an alarm generation signal to the alarm generation section 16 based on an abnormality detection signal from the abnormality detection section 15, and stores the abnormality detection signal in the information storage section 17.

The information storage section 17 stores process information and alarm information as a process history in a time-sequential manner in a real process, and prestores an alarm table describing the contents of each alarm, alarm by alarm. An ID is affixed to an alarm, and the ID is also described in the alarm table so that each alarm is called by that ID. Contents described in the alarm table include information on what each alarm is warning (description of the alarm), one or two or more possible brief reasons for generation of the alarm, and brief feasible actions or the like for the individual reasons for generation. The alarm table is linked to the stored process history, so that information relating to alarm generation can be called.

When a predetermined alarm is selected by the operation section 22, the alarm-related information acquisition section 18 selectively acquires information relating to that alarm from information stored in the information storage section 17. Specifically, an alarm with a predetermined ID is selected from the alarm table stored in the information storage section 17, information relating to the selected alarm linked to the alarm table, specifically, sequential detailed information leading to alarm generation, can be acquired selectively, and further relating I/O address information (I/O name, I/O information and I/O address) around the alarm generation and timer information can be acquired selectively. In this case, it is possible to set a predetermined time around alarm generation and select information during that time. Information on the alarm selected by the alarm-related information acquisition section 18 this way can be displayed on the monitor 21.

As a specific display example of the monitor 21 which relates to an alarm, when a predetermined is selected, the description of the contents of that alarm, one or two or more possible reasons for generation of the alarm, a screen displaying brief feasible actions for individual reasons for generation (screen 1), a screen of detailed description of sequential information leading to generation of the alarm for each of patterns of reasons for generation (screen 2), and a screen displaying relating I/O address data around alarm generation (screen 3). The screen 2 can be displayed by touching (clicking) a predetermined position provided on the screen 1, and the screen 3 can be displayed by touching (clicking) a predetermined position provided on the screen 2.

Next, one example of the process apparatus 10 will be discussed. FIG. 2 is a perspective view of the process apparatus 10, and FIG. 3 is a plan view thereof.

The process apparatus 10 mainly comprises a load/unload section 31 which performs loading and unloading and storage or so of a carrier C where a wafer W is retained horizontally, a processing section 32 which performs a cleaning process on the wafer W using a predetermined chemical solution and a drying process or the like, and an interface section 33 which conveys the wafer W between the load/unload section 31 and the processing section 32.

The load/unload section 31 comprises a carrier load/unload section 34 where a stage 41 for mounting a carrier C capable of retaining a predetermined number of, for example, twenty-five, wafers W is formed, and a carrier stock section 35 capable of storing a plurality of carriers C. The carrier C retains wafers W horizontally at predetermined intervals, with its one side being a load/unload port for the wafers W, which has such a structure as to be openable and closable with a lid. The carrier stock section 35 is provided with a plurality of carrier holding members 43 which hold the carriers C. A carrier C which retains unprocessed wafers W and is mounted on the stage 41 is carried into the carrier stock section 35 by a carrier conveying device 42, while a carrier C which retains processed wafers W is carried to the stage 41 from the carrier stock section 35 using the carrier conveying device 42.

A shutter 44 is provided between the carrier load/unload section 34 and the carrier stock section 35. The shutter 44 is opened at the time of transferring the carrier C between the carrier load/unload section 34 and the carrier stock section 35, and is closed otherwise to isolate the atmosphere between the carrier load/unload section 34 and the carrier stock section 35.

The carrier conveying device 42 has an arm 42a, such as a multi-joint arm or a telescopic arm, which is driven in such a way as to be able to move at least a carrier C, for example, in the X direction, and the carrier C is conveyed held with such an arm 42a. The carrier conveying device 42 can be driven in the Y direction and Z direction (height direction) by an unillustrated Y-axis drive mechanism and Z-axis drive mechanism, so that the carrier C can be mounted on the carrier holding member 43 laid out at a predetermined position.

In FIG. 3, the carrier holding members 43 are provided near the wall surface where the carrier stock section 35 is formed, in plural stages, for example, four stages, at each location in the height direction. The carrier stock section 35 serves to temporarily store carriers C retaining unprocessed wafers W, or store empty carriers C from which the wafers W have been removed.

A window 46 is formed at the boundary between the carrier stock section 35 and the interface section 33, and an inspection/load/unload stage 45 having a structure similar to that of the carrier holding member 43 is provided on the carrier stock section 35 side of the window 46 so that the carrier C can be mounted in such a way that the lid of the carrier C faces the window 46. The carrier conveying device 42 may hold the carrier C for a given time at predetermined space facing the window 46 without providing the inspection/load/unload stage 45. A lid open/close mechanism 47 for opening and closing the lid of the carrier C mounted on the inspection/load/unload stage 45 is provided on the carrier stock section 35 side of the window 46, so that with the window 46 and the lid of the carrier C being open, the wafers W in the carrier C can be carried out toward the interface section 33, or wafers W can be carried into an empty carrier C from the interface section 33 side. The lid open/close mechanism 47 may be provided on the interface section 33 side of the window 46.

A wafer inspecting device 48 for measuring the quantity of wafers W in the carrier C is provided on the interface section 33 side of the window 46. The wafer inspecting device 48 checks the quantity of the wafers W by causing, for example, an infrared sensor head having a transmission section and a reception section to scan in the Z direction in the vicinity of the X-directional ends of the wafers W retained in the carrier C and detecting a signal of transmitted light or reflected light of the infrared light between the transmission section and the reception section. It is preferable to use the wafer inspecting device 48 that has a function of detecting the retained state of wafers W, such as whether or not the wafers W are laid out one on another in parallel at predetermined pitches in the carrier C or whether or not the wafers W are retained misaligned and obliquely, in parallel to checking of the quantity of wafers W. The quantity of the wafers W may be detected using the sensor after the retained state of the wafers W is checked. The wafer inspecting device 48 is wire-connected as a signal input device to the block controller (BC) 11, and sends the detected quantity retained and the retained state as output signals to the block controller (BC) 11.

The operations of the carrier conveying device 42 and the wafer inspecting device 48 are controlled by the host computer 15 via the block controller (BC) 11 and the main controller (MC) 12. For example, the carrier conveying device 42 is controlled in such a way that after the quantity of wafers W in a carrier C is checked by the wafer inspecting device 48, the carrier C is stored in the carrier stock section 35. The opening/closing of the shutter 44, the opening/closing of the window 46 and the operation of the lid open/close mechanism 47 are controlled interlocked with the movement of the carrier conveying device 42.

The interface section 33 is provided with a wafer load/unload device 49, a wafer transfer device 51 and a wafer conveying device 52. The wafer transfer device 51 comprises an attitude conversion mechanism 51a which exchanges a wafer W with the wafer load/unload device 49 and converts the attitude of the wafer W, and a wafer vertical holding mechanism 51b which exchanges a wafer W between the attitude conversion mechanism 51a and the wafer conveying device 52.

The wafer load/unload device 49 unloads wafers W in the carrier C through the window 46 and transfers it to the attitude conversion mechanism 51a, and receives wafers W having undergone the liquid process from the attitude conversion mechanism 51a and carries into the carrier C. The wafer load/unload device 49 has two kinds of arms, arms 49a which carry unprocessed wafers W and arms 49b which carry a processed wafers W. A predetermined number of the arms 49a and 49b are laid out at predetermined intervals in the Z direction according to the layout pitch of wafers W in the carrier C, so that the arms 49a and 49b can hold plural wafers W retained in the carrier C at a time. In the state shown in FIG. 3, the arms 49a and 49b are movable (slidable) or expandable in the direction of an arrow A, and are elevatable by a predetermined distance in the Z direction. Further, the entire wafer load/unload device 49 is so constructed as to be rotatable in a θ direction, so that the arms 49a and 49b can access to any of the carrier C mounted on the inspection/load/unload stage 45, and the attitude conversion mechanism 51a.

In the wafer load/unload device 49, for example, with the arms 49a being on the wafer transfer device 51 side, the arms 49a are inserted under the wafers W and is lifted upward by a predetermined distance to hold the wafers W, after which the arms 49a are moved in the opposite direction to carry out the wafer W of the carrier C. Next, the whole wafer load/unload device 49 is rotated by 90 degrees, and then the arms 49a are moved to transfer the wafers W held on the arms 49a to the attitude conversion mechanism 51a. With the arms 49b being on the processing section 32 side, on the other hand, the arms 49b are moved to take out wafers W having undergone the liquid process from the attitude conversion mechanism 51a, after which the whole wafer load/unload device 49 is rotated by 90 degrees, and then the arms 49b are set on the wafer transfer device 51 side and are moved to carry the wafers W held on the arms 49b moved to transfer the wafer W held on the arm 49b into an empty carrier C.

In the attitude conversion mechanism 51a of the wafer transfer device 51, a plurality of horizontal wafers W are received from the wafer load/unload device 49 through a guide member, and the guide member is rotated in that state to change the state of the wafers W to the vertical state.

The wafer vertical holding mechanism 51b can retain two carriers of, or 50, wafers W whose state has been changed to the vertical state by the attitude conversion mechanism 51a at a layout pitch which is half the layout pitch of wafers in the carrier C, and transfers the two carriers of wafers W to the wafer conveying device 52.

The wafer conveying device 52 delivers vertical wafers W to or from the wafer vertical holding mechanism 51b and carries unprocessed wafers W into the processing section 32, or carries out wafers W having undergone the liquid process or so from the processing section 32 and transfers the wafers W to the wafer vertical holding mechanism 51b. In the wafer conveying device 52, wafers W are held by three chucks 58a to 58c. The wafer conveying device 52 moves in the X direction along a guide rail 53 to be able to move into/out from the processing section 32 in such a way that the wafer conveying device 52 can deliver wafers W to or from the wafer vertical holding mechanism 51b and carry wafers W into the processing section 32.

To check whether or not wafers W having undergone the liquid process are damaged or misaligned or so, a wafer detection sensor 57 to check the layout state of wafers W is provided at a position where the wafers W are delivered between the wafer vertical holding mechanism 51b and the wafer conveying device 52. The wafer detection sensor 57 is not limited to such a position but can be any position where a check is done while processed wafers W are carried to the wafer load/unload device 49. The wafer detection sensor 57 is wire-connected as a signal input device to the block controller (BC) 11 and sends the detected value as an output signal to the block controller (BC) 11.

The interface section 33 is provided with a parking area 40a on the side of the position where wafers W are exchanged between the wafer vertical holding mechanism 51b and the wafer conveying device 52, so that unprocessed wafers W, for example, can stand by in the parking area 40a. For instance, at the time the liquid process or the dry process is performed on wafers W of one lot, wafers W for which the liquid process are to be initiated next should have been carried to the parking area 40a using the time during which the wafer conveying device 52 need not be operated. This can shorten the time for moving wafers W to the processing section 32 as compared with, for example, a case where wafers W are carried from the carrier stock section 35, so that the throughput can be improved.

The processing section 32 comprises a liquid process unit 38, a drying unit 39, and a parking area 40b, which are arranged in the order of the drying unit 39, the liquid process unit 38 and the parking area 40b from the interface section 33 side. The wafer conveying device 52 can move inside the processing section 32 along the guide rail 53 extending in the X direction.

The parking area 40b, like the parking area 40a, is where unprocessed wafers W are to sand by. Using the time during which the wafer conveying device 52 need not be operated for the liquid process or the dry process is performed on wafers W of one lot, wafers W for which the liquid process are to be initiated next are carried to the parking area 40b. As the parking area 40b is adjacent to the liquid process unit 38, the time for moving wafers W can be shortened at the time of initiating the liquid process, so that the throughput can be improved.

The liquid process unit 38 has a first chemical bath 61, a second chemical bath 63, a third chemical bath 65, a first rinse bath 62, a second rinse bath 64, and a third rinse bath 66, which are arranged in the order of the first chemical bath 61, the first rinse bath 62, the second chemical bath 63, the second rinse bath 64, the third chemical bath 65, and the third rinse bath 66 from the parking area 40b side, as shown in FIG. 3. A conveying device 67 for transferring wafers W between the first chemical bath 61 and the first rinse bath 62, a conveying device 68 for transferring wafers W between the second chemical bath 63 and the second rinse bath 64, and a conveying device 69 for transferring wafers W between the third chemical bath 65 and the third rinse bath 66 are provided.

A chemical solution for removing an organic stain or a surface metal impurity is retained in the first chemical bath 61. As a chemical solution for removing an organic stain or a surface metal impurity, an SPM solution (a mixed solution of concentrated sulfuric acid and a hydrogen peroxide solution) heated to, for example, around 130° C. is retained. A chemical solution for removing a deposit, such as particles, e.g., an SC-1 solution (a mixed solution of ammonia, hydrogen peroxide and water) is retained in the second chemical bath 63, and an etchant for etching an oxide film formed on the top surface of a wafer W, e.g., a diluted hydrofluoric acid (DHF), is retained in the third chemical bath 65. As an etchant, in addition to the diluted hydrofluoric acid, a mixture of a hydrofluoric acid (HF) and ammonium fluoride (buffered hydrofluoric acid (BHF)) can be used. In case of etching a nitride film formed on the top surface of a wafer W, phosphate can be used as an etchant. The first to third rinse baths 62, 64 and 66 are for respectively removing chemical solutions adhered to a wafer W through the liquid processes in the first to third chemical baths 61, 63 and 65, and various kinds of rinsing schemes, such as overflow rinse and quick dump rinse, are used.

the conveying device 67 has a drive mechanism elevatable in the Z direction, and operates in such a way as to lower wafers W received from the wafer conveying device 52 to be bathed in the first chemical bath 61, pull them up after a predetermined time, then move the wafers W in parallel in the X direction, bathe and hold the wafers W in the first rinse bath 62 for a predetermined time, then pull them up. The wafers W that have undergone the process in the first rinse bath 62 are returned to the chucks 58a to 58c of the wafer conveying device 52, and then are carried to the conveying device 68 from the wafer conveying device 52. The conveying devices 68 and 69 have structures similar to the structure of the conveying device 67, and operate similarly.

A liquid-process-unit thermometer 59 which detects the temperature of the atmosphere in the liquid process unit 38, and a liquid-process-unit manometer 60 which detects pressure are provided in the liquid process unit 38. The liquid-process-unit thermometer 59 and the liquid-process-unit manometer 60 are wire-connected as signal input devices to the block controller (BC) 11, and respectively send the detected temperature and pressure to the block controller (BC) 11.

The drying unit 39 is provided with a rinse bath 54 and a chuck cleaning mechanism 56 which cleans the chucks 58a to 58c of the wafer conveying device 52, and a dry chamber (not shown) to which vapor of, for example, isopropyl alcohol (IPA) is supplied to dry wafers W is provided at the upper portion of the rinse bath 54. A conveying device 55 which conveys between the rinse bath 54 and the dry chamber is provided so that wafers W rinsed in the rinse bath 54 are pulled up and subjected to IPA drying in the dry chamber. The conveying device 55 is constructed in a similar way as the above-described conveying device 67 or the like, except that it cannot move in the X direction, so that exchange of the wafers W with the wafer conveying device 52 is possible.

The first chemical bath 61, as shown in FIG. 4, comprises a box-shaped inner bath 80 with sizes large enough to retain wafers W and outer bath 81. The top side of the inner bath 80 is open, so that wafers W are carried in and out of the inner bath 80 through the opening at the top side. The outer bath 81 is attached surrounding the opening of the inner bath 80 in such a way as to receive a chemical solution overflowing from the top end of the inner bath 80. Further, liquid level sensors 82a and 82b for measuring the positions of the liquid levels are provided at the liquid levels of the chemical solutions to be retained in the inner bath 80 and the outer bath 81. Those liquid level sensors 82a and 82b are wire-connected as signal input devices to the block controller (BC) 11, and send the detected positions of the liquid levels to the block controller (BC) 11 as output signals.

A circulation supply circuit 84 which supplies a chemical solution in circulation during the etching of wafers W is connected between the inner bath 80 and the outer bath 81. One of the circulation supply circuit 84 is connected to the bottom of the outer bath 81, a pump 86, a temperature control unit 88 and a filter 90 are laid out in order in a midway of the circulation supply circuit 84, and the other of the circulation supply circuit 84 is connected to a nozzle in the inner bath 80. Therefore, the chemical solution which has overflowed from the inner bath 80 to the outer bath 81 flows into the circulation supply circuit 84, passes the temperature control unit 88 and the filter 90, in order, for temperature regulation and filtering by the activation of the pump 86, and then is supplied into the inner bath 80 again through the nozzle. The nozzle is laid out under the outer bath 81 and is so constructed as to supply a chemical solution toward the top surface of the wafer W.

The temperature control unit 88 has a function of pre-cooling or pre-heating a chemical solution to be supplied into the inner bath 80 from the circulation supply circuit 84 before bathing so that the temperature of the chemical solution in the inner bath 80 does not become lower than or higher than a predetermined process temperature. The supply of a pre-cooled or pre-heated chemical solution into the inner bath 80 this way can keep the temperature of the chemical solution in the inner bath 80. The temperature control unit 88 is wire-connected as a signal output device to the block controller (BC) 11, and receives a control signal output from the block controller (BC) 11. For instance, the temperature control unit 88 comprises a heater, a heat exchanger and coolant supply means, and a valve disposed in the coolant supply passage for supplying a coolant into the heat exchanger and the heater are connected to the block controller (BC) 11. A predetermined control signal is sent to either the heater or the valve via the block controller (BC) 11 as needed.

A branch pipe 92 for flow of the chemical solution in the circulation supply circuit 84 to the outer bath 81 is connected to a midway of the circulation supply circuit 84, and the branch pipe 92 is provided with a concentration/temperature detecting section 95 for detecting the concentration and the temperature of a chemical solution. The concentration/temperature detecting section 95 is wire-connected to the block controller (BC) 11 as a signal input device. The concentration/temperature detecting section 95 is provided with a thermometer 95a which detects the temperature of the chemical solution, and a densitometer 95b which detects the concentration of the chemical solution, and they send the detected temperature and concentration as output signals to the block controller (BC) 11.

The branch pipe 92 is thinner than the pipe of the circulation supply circuit 84; for example, the diameter of the branch pipe 92 is ⅓ of the diameter of the circulation supply circuit 84. In this case, as generation of turbulence can be prevented, ultrasonic waves to be used in measuring the concentration are not influenced by the eddy flow even when an ultrasonic densitometer is used in the concentration/temperature detecting section 95. The influence of a change in pressure of the chemical solution, caused by driving of the pump 86, on measurement of the concentration is suppressed. Therefore, highly accurate concentration measuring is possible.

The first chemical bath 61 is provided with a chemical-solution supply circuit 100 for filling the bath with a chemical solution. The chemical-solution supply circuit 100 has a chemical-solution source 101, a pure-water source 102 and a mixture supply section 103 which mixes a chemical solution and pure water. The mixture supply section 103 is wire-connected to the block controller (BC) 11 as a signal output device. The chemical-solution supply circuit 100 serves as chemical solution supplementing means, and is controlled in such a way as to supplement the chemical solution from the chemical-solution source 101, the pure-water source 102 when the concentration of the chemical solution in the first chemical bath 61 drops.

The other end of the chemical-solution supply circuit 100 is connected to the outer bath 81, so that the adjusted chemical solution temporarily flows to the circulation supply circuit 84, and is supplied to wafers W from below the inner bath 80 after its temperature is adjusted.

As the first and second chemical baths 63 and 65 have structures and functions nearly the same as those of the first chemical bath 61 and the piping system discussed above, the descriptions will be omitted. The first to third rinse baths 62, 64 and 66 basically have similar structures and functions. That is, they have a rinse bath comprising an inner bath and an outer bath, and a circulation supply circuit from which pure water is supplied to the rinse bath.

As described above, the process apparatus 10 has various detection means which detect the statuses of the individual components. That is, as mentioned above, the liquid-process-unit thermometer 59 and the liquid-process-unit manometer 60 are provided as detection means to detect the status of the atmosphere in the liquid process unit 38. The liquid level sensors 82a and 82b, and the thermometer 95a and the densitometer 95b of the concentration/temperature detecting section 95 are provided as detection means to detect the statuses of the first chemical bath 61 and the individual sections of its piping system. Similar liquid level sensors, and the thermometer and the densitometer of the concentration/temperature detecting section are provided in the second and third chemical baths 63 and 65 and the piping systems. Further, the wafer inspecting device 48 is provided at the interface section 33 as detection means to detect the storage state of wafers W, and the wafer detection sensor 57 is provided as detection means to detect the layout state of wafers W. Other various detection means are provided. They perform predetermined detections as described above, and send the detected values as output signals to the block controller (BC) 11 as shown in FIG. 5.

The output signals of the wafer inspecting device 48, the wafer detection sensor 57, the liquid-process-unit thermometer 59, the liquid-process-unit manometer 60, the liquid level sensors 82a and 82b, the thermometer 95a and the densitometer 95b provided in the concentration/temperature detecting section 95, and other multiple detection means are sent to the block controller (BC) 11 at predetermined time intervals, are sent to the AGC 17 via the main controller (MC) 12, and are detected as detection signals representing the statuses of the individual sections of the process apparatus, so that changes in the statuses of the individual sections of the process apparatus can be detected. Further, when the abnormality detecting section 20 of the main controller (MC) 12 detects a detection signal exceeding an allowable value, the alarm generation section 21 generates an alarm to the operator.

Next, the control operation of the process system will be described.

In the process apparatus 10, a carrier C constituting one lot is placed on the inspection/load/unload stage 45 from the load/unload section 31 or the carrier stock section 35 using the carrier conveying device 42, the lid of the carrier C is opened by the lid open/close mechanism 47, further the window 46 is opened, and the quantity and the storage state of wafers W retained in the carrier C are checked by the wafer inspecting device 48. The carrier C whose abnormality has not been detected by the check is given to the attitude conversion mechanism 51a by the arm 49a, and is given to the wafer vertical holding mechanism 51b after its posture is converted by the attitude conversion mechanism 51a. For the other carrier C, the posture conversion of wafers W is carried out by the attitude conversion mechanism 51a and the wafers W are given to the wafer vertical holding mechanism 51b. Accordingly, 50 wafers W are aligned in the wafer vertical holding mechanism 51b.

The wafer vertical holding mechanism 51b is slid toward the wafer conveying device 52 and the wafers W are transferred to the chucks 58a to 58c. The wafer conveying device 52 holding the wafers W is moved to the position of the first chemical bath 61 or the first rinse bath 62 of the liquid process unit 38 along the guide rail 53, the wafers W are transferred to the conveying device 67, and the liquid process on the wafers W is initiated. The liquid process the wafers W is carried out in the order of, for example, soaking into the first chemical bath 61 and rinsing in the first rinse bath 62, basing into the second chemical bath 63 and rinsing in the second rinse bath 64, and soaking into the third chemical bath 65 and rinsing in the third rinse bath 66.

The wafers W whose processing in the liquid process unit 38 is finished are transferred to the wafer conveying device 52, and then transferred to the conveying device 55 of the drying unit 39 to undergo the dry process. The wafers W that has undergone the dry process are transferred to the wafer conveying device 52, and are returned to the interface section 33 for checking the status of the wafers W by the wafer detection sensor 57. If an abnormality in the status of the wafers W is detected, an action, such as stopping the liquid process apparatus 1 and doing maintenance, is taken. The wafers W which have undergone the liquid process and are returned to the interface section 33 can be retained in an empty carrier C mounted on the inspection/load/unload stage 45 in the opposite procedures to the procedures of carrying unprocessed wafers W from the carrier stock section 35 to the wafer conveying device 52. The carrier C where the wafers W which have undergone the liquid process are retained is carried to the carrier load/unload section 34 to be sent to the next step.

The processing operation on the wafer W as an object to be processed is executed while being controlled by the block controller (BC) 11 and the main controller (MC) 12 based on detection signals from the wafer inspecting device 48, the wafer detection sensor 57, the liquid-process-unit thermometer 59, the liquid-process-unit manometer 60, the liquid level sensor 82, the thermometer 95a and the densitometer 95b provided in the concentration/temperature detecting section 95, and other multiple detection means.

Specifically, the detection signals from those detection means are sent to the control unit 13 in the main controller (MC) 12 via the block controller (BC) 11, and the control unit 13 sends predetermined control signals to the process apparatus 10 based on those signals and executes a series of rinsing processes based on those control signals.

Process information including those detection signals from the process apparatus 10 are sent to the control unit 13 in the main controller (MC) 12 via the block controller (BC) 11, and is stored in the information storage section 17 after undergoing signal processing. The process information is also sent to the abnormality detection section 15. When the process information is off a predetermined set value, it is determined as abnormal, an abnormality detection signal is sent to the control unit 13, which sends an alarm generation signal to the alarm generation section 16 based on the abnormality detection signal and the alarm generation section 16 generates an alarm. Generation of an alarm is done by displaying it on the monitor 21 in addition to generation of a sound or optical information. The alarm generation signal is also sent to the information storage section 17 to be stored as a process history.

In acquiring information on an alarm, as a predetermined alarm is selected through the operation section 22, the alarm-related information acquisition section 18 selects the alarm from the alarm table stored in the information storage section 17, acquires detailed sequential information relating to the alarm in the process history linked to the alarm and I/O address information and timer information relating to the selected alarm, and can display the acquired alarm information on the monitor 21.

For example, the contents of an alarm which is generated when liquid level sensors 82a and 82b detect the lower limit of the liquid level in the first chemical bath 61 (the inner bath 80 and outer bath 81) are described in the alarm table as shown in FIG. 6. That is, 3071 is assigned as an alarm ID, the alarm indicating the detection of the lower limit of the chemical bath is described as the contents of the alarm, the detailed description thereof is described, circulation being executed with no liquid (reason 1), bad adjustment of the position of the sensor (reason 2), and the liquid discharge valve failed or the chemical bath broken (reason 3) are described as briefs of possible reasons for alarm generation, and briefs of measures (actions) against them reason by reason. Link information to be discussed later is described in the alarm table. When the alarm-related information acquisition section 18 selects the alarm, the monitor 21 shows the screen (screen 1) that displays the aforementioned contents as shown in FIG. 7.

Detailed sequential information leading to generation of an alarm in the process history linked to alarm information in the alarm table can be selected for each of the reasons, and the screen of the monitor 21 then becomes as shown in FIG. 8 (screen 2). Specifically, a screen (“Pattern 1”) corresponding to reason 1 in FIG. 8 is displayed by touching the “Detail” portion in FIG. 7. This example shows that the circulation pump is enabled to start circulation, and the level sensor is switched off. At this time, detailed sequential information leading to generation of alarms corresponding to reason 2 and reason 3 can be acquired selectively by touching (clicking) “Pattern 2” and “Pattern 3” portions.

Further, touching (clicking) the “Currently View2 portion on the screen in FIG. 8 provides a screen showing relating I/O names and I/O information around alarm generation shown in FIG. 9 (screen 3). Here, the I/O names, CIRC_PUMP_START, OUTER_BATH_LOWER_LIMIT (lower limit of the outer bath), and INNER_BATH_LOWER_LIMIT (lower limit of the inner bath), corresponding to the start of the circulation pump are displayed, and those I/O information (ON/OFF information) is displayed. The hatched portion of the I/O information is an ON state, and the horizontal axis is the time axis. Specifically, it is apparent from the screen that while the circulation pump is in the ON state around generation of an alarm, the lower limit of the outer bath and the lower limit of the inner bath are switched OFF from ON at the time of alarm generation and remains OFF thereafter. It is specified from this that the cause for the alarm generation corresponds to the level sensor. Further, an I/O address can also be specified on the screen by displaying the I/O address on the display screen. The screen has the Parameter column where parameters (process information) linked to an alarm are to be displayed. In this example, it is indicated that there is no information to be displayed in the Parameter column.

For other alarms, the alarm-related information acquisition section 18 can select the an alarm from the alarm table stored in the information storage section 17, selectively acquire detailed sequential information relating to the alarm in the process history linked thereto, and I/O address data and timer information relating to the selected alarm, and display the acquired alarm information on the monitor 21.

Conventionally, when an alarm is generated, brief information on at which part the alarm is generated is acquired, but detailed information or the like on the apparatus which has led to the alarm generation is not acquired, making it difficult to specify the location of the cause for the alarm generation, so that it takes a long time for an operator to find the location of the cause for alarm generation and restore the process apparatus. According to the embodiment, by way of contrast, sequential information on a predetermined alarm leading to generation of the alarm can be grasped in detail to the level of I/O address data, making is possible to easily specify the location of the cause for the alarm generation. As an abnormality at the location of the cause for the alarm generation can be removed promptly, therefore, the process apparatus 10 can be restored in a short period of time when an abnormality occurs in the process apparatus, so that the down time of the process apparatus 10 can be shortened.

The alarm table describes information, such as information on what each alarm is warning (description of the alarm), one or two or more possible brief reasons for generation of the alarm, and brief feasible actions for the individual reasons for generation, the information is displayed, and detailed sequential information up to the generation of the linked alarm is displayed. Even if the level of the skill of the operator is low, therefore, it is possible to surely grasp alarm information and take the adequate action.

Because the process history to be stored in the information storage section 17 includes abnormality detection data and alarm information as mentioned above, information about a trouble which has occurred in the process apparatus 10 is stored too. When a trouble occurs next, therefore, the cause for an abnormality can be predicted efficiently by extracting related information from the data stored in the information storage section 17. In this case, it is preferable that the related information should be retrievable with an arbitrary keyword.

Next, a process system according to another embodiment of the invention will be described. Although the foregoing description of the embodiment has been given of the process system when there is one process apparatus 10, the process system which controls a plurality of process apparatuses 10 at a time will be discussed here.

FIG. 10 is a block diagram showing a process system according to the embodiment. This process system 1′ has a plurality of process apparatuses 10 each of which is controlled by a block controller (BC) 11′ as a low-rank control system and a main controller (MC) 12′ as a high-rank control system. The process system 1′ has a host computer 115 which performs the general control of the system, and an advanced group controller (hereinafter written as AGC) 117 which analyzes process data generated by the control systems of the individual process apparatuses and outputs the results. Each process apparatus 10 includes a plurality of detection means which, like those of the previous embodiment, detect various process statuses, and the detection information is input to the block controller (BC) 11′ and sent to the host computer 115 and the AGC 117 via the main controller (MC) 12′.

As shown in FIG. 11, the main controller (MC) 12′ has a control unit 110, which receives a detection signal through the block controller (BC) 11 and sends a control signal to the individual components of the process apparatus 10 based on the detection signal, an abnormality detecting section 111, which analyzes process information received from the control unit 110 and detects an abnormality, an alarm generation section 112 which generates an alarm based on abnormality detection information from the abnormality detecting section 111, a memory 118 where entire process information and alarm information, which are received from the process apparatus 10 via the block controller (BC) 11 and subjected to signal processing in the control unit 110, are temporarily stored, an HCI transmission buffer 119, which acquires some preset types of process data (data 1, 3) from the memory 118 and writes the information, an HCI (Host Communication Interface) 113 as logical interface means to the host computer 115, and an RAP (Remote Agent Process) 116 as logical interface means to an AGC 117. Exchange of various kinds of data with the host computer 115 through a data transmission system 114, such as TCP/IP, is executed by the HCI 13. Exchange of various kinds of data with the AGC 17 is executed by the RAP 116 through the data transmission system 114.

The HCI 113 selects some preset types of process data from all the process data acquired from the process apparatus 10 by the main controller 12′, and sends the data to the host computer 115. That is, the HCI 113 acquires some preset types of process data (data 1, 3) from the memory 118 where entire process data generated by the main controller (MC) 12′ are temporarily stored, writes the data in the HCI transmission buffer 119, and sends the contents of the HCI transmission buffer 119 to the host computer 115 at a time. Status data or the like generated by the main controller (MC) 12′ is also sent.

The RAP 116 sends all the process data acquired from the process apparatus 10 by the main controller (MC) 12′ to the AGC 117 unconditionally. That is, the RAP 116 sequentially reads process data, stored in the process data storage memory 118 in the main controller (MC) 12′, from the top, and transfers it with the data structure unchanged to the AGC 117. It is to be noted however that an operation to an extent, such as changing the sequential order of data or removal of just a part of data may be carried out here.

The host computer 115 performs the general operational control of the individual process apparatuses 10, such as tracking of each process apparatus 10 through exchange of various kinds of data with the main controller (MC) 12 of each process apparatus 10.

The AGC 117 executes processes including intensive management of recipes (process condition values) for each process apparatus and process control of each process apparatus 10 based on the recipes, analysis and statistical processing of all process data acquired from each process apparatus 10, intensive monitoring of process data and its analysis/statistical results, a process of reflecting the analysis/statistical results on recipes, and the like.

The AGC 117 comprises an AGC server 117a and an AGC client 117b.

The AGC server 117a has a communication I/F (Interface section) 121, an EQM control unit 122 and an information storage section 123. The communication I/F (Interface section) 121 transmits and receives various kinds of data between the main controller (MC) 12′ of each process apparatus 10 and the AGC client 117b via the data transmission system 114. The EQM control unit 122 mainly performs correction of various parameters of processes for each process apparatus based on predefined process conditions and process information acquired from each process apparatus 10, and processes, such as storage of received process information and alarm information, and received parameters into the information storage section 123, and retrieval of process data to be transferred to the AGC client 117b from the information storage section 123.

The AGC client 117b has a data analysis section 125, which performs analysis and statistical processing of process data transferred from the AGC server 117a, a data converting section 126 which converts acquired process data and its analysis results or the like to data of the format that a client user can use and process, a data display section 127 which controls display of converted data on a monitor (not shown), a recipe correcting section 128 which updates recipes (process conditions) for optimization based on the results of analysis of process data including measured data of the film thickness and the like on an object to be processed, and an alarm-related information acquisition section 129 which selectively acquires information about individual alarms, acquired from the individual process apparatuses 10, from the information storage section 123.

In the process system 1′, each process apparatus 10 performs a process on a wafer W as an object to be processed through quite the same processing operation done by the previous embodiment. In this case, the processing operation on wafers W as subjects to be processed is controlled and executed by the associated block controller (BC) 11′ and main controller (MC) 12′ under the process control of the host computer 115 and the AGC 117.

In each main controller (MC) 12′, process data acquired from the process apparatus 10 through the block controller (BC) 11′ is written in the process data storage memory 118 via the control unit 110. The process data written in the memory 118 is transferred to the host computer 115 and the AGC 117 through an independent channel of the data transmission system 114, such as TCP/IP, by the HCI 13 and the RAP 116 which are logical interface means associated with external transfer of the process data.

The AGC server 117a of the AGC 117 receives the process information and alarm information transmitted by the RAP 116 of the main controller (MC) 12′ of each process apparatus 10, stores those information in the information storage section 123, generates a parameter correction value of each process apparatus 10 from the process information and recipe data, sends the value to the main controller (MC) 12′, and sends control signals to the individual components of each process apparatus 10 from the control unit 110 of the main controller (MC) 12′ via the block controller (BC) 11′, thereby performing process control.

When receiving a process data transfer request from the AGC client 117b, the AGC server 117a reads the corresponding process data from the information storage section 123, and transmits the data to the AGC client 117b via the communication I/F 121. The process data transferred to the AGC client 117b is converted by the data converting section 126 to data of the format that a client user can use and process, and information to be displayed on the monitor is controlled by the data display section 127. Further, the process data transferred to the AGC client 117b is subjected to analysis and statistical processing in the data analysis section 125, and the analysis results, like the process data, are converted by the data converting section 126 to data of the format that a client user can use and process, and are displayed on the monitor. This achieves integrated control of the entire substrate process system on the AGC client 117b.

The data analysis section 125 of the AGC client 117b performs abnormality detection and abnormality prediction of the process apparatus from the results of analyzing the process data in addition to detection of an abnormality in each process apparatus and generation of an alarm, and, when detecting or predicting an abnormality, sends an output to that effect to the monitor, and informs the AGC server 117a of that effect. According to the notification, the AGC server 117a performs such control as instructing stopping of the main controller (MC) 12′ which is controlling the process apparatus 10 whose abnormality is detected or predicted.

Further, the recipe correcting section 128 of the AGC client 117b performs an update process to optimize recipes (process conditions) from the results of analysis on the process data including measured data, such as the results of measuring the film thickness on the substrate.

In acquiring information on alarms of the individual process apparatuses 10, for the selected alarm, the alarm-related information acquisition section 129 selects the alarm from the alarm table stored in the information storage section 123, selectively acquires detailed sequential information relating to the alarm in the process history linked thereto, and I/O address data and timer information relating to the selected alarm, and displays the acquired alarm information on the monitor, as done in the previous embodiment.

Even in the present embodiment, as sequential information leading to generation of a predetermined alarm can be grasped in detail to the level of I/O address data from the process history stored in the information storage section 123, the location of the cause for the alarm generation can be specified easily and an abnormality at the location of the cause for the alarm generation can be removed quickly. When an abnormality occurs in an process apparatus 10, therefore, the process apparatus can be restored in a short period of time and the down time of the process apparatus can be shortened.

In addition, when the host computer 115 is downed, spooling process of process data by the AGC 117 is performed in the present embodiment. That is, after recovery, the host computer 115 can immediately acquire process data over the down period from the AGC 117. Accordingly, the tracking process of each process apparatus 10 by the host computer 115 can be resumed immediately after recovery.

According to the embodiment, all or nearly all of detailed process data acquired from each process apparatus 10, typified by detection signals from the wafer inspecting device 48, the wafer detection sensor 57, the liquid-process-unit thermometer 59, the liquid-process-unit manometer 60, the liquid level sensors 82a and 82b, the thermometer and the densitometer provided in the concentration/temperature detecting section 95, etc., can be taken into the AGC 117 and intensively monitored, a change in the status of each process apparatus with time can be detected early in addition to detection of an abnormality in each process apparatus 10 and generation of an alarm. This can enhance the maintenance reliability of the process system including multiple process apparatuses 10. According to the embodiment, optimal process conditions can be automatically acquired from various viewpoints taking into account a change in the characteristic of each process apparatus 10 with time by updating individual pieces of data in recipes to more preferable values from results of analysis and results of statistics done on detailed process data including measured data, such as the measured result of the film thickness on the substrate, so that the reliability of the liquid process of wafers W can be improved.

By fetching process data acquired from each process apparatus 10 into the AGC 117 and performing intensive monitoring this way, the range of information that can be grasped as the statuses of the individual process apparatuses is widened so that an abnormality in apparatus, the degradation state, and the service life can be detected in greater details and earlier as compared with the case where the AGC 117 is not provided.

The invention is not limited to the embodiments, but can be modified in various forms. Although the foregoing description of the embodiments have been given of, as an example, the apparatus which cleanings wafers by performing a liquid process thereon, for example, it is not restrictive but can be adapted to other process apparatuses. An object to be processed is not limited to a wafer. It is to be noted however that in case of an apparatus which performs a sequence of processes on an object to be processed as done in the process apparatus of the embodiment, the invention is particularly effective for there are multiple types of information to be detected and the types of alarms are vast accordingly.

1. A process system comprising:
a process apparatus which performs a predetermined process on an object to be processed;
a plurality of detection means which detect statuses in the process apparatus;
an abnormality detection section which detects an abnormality in detection information from the plurality of detection means;
an alarm generation section which generates an alarm when the abnormality detection section detects an abnormality;
an information storage section which stores the detection information from the detection means and alarm information as a process history of the process apparatus;
an alarm-related information acquisition section which acquires information relating to an alarm selected from generated alarms from the information storage section; and
a display section which displays alarm-related information acquired by the alarm-related information acquisition section.

2. The process system according to claim 1, wherein the alarm-related information includes I/O address information relating to the alarm.

3. The process system according to claim 1, wherein the information storage section prestores brief information on alarms according to types of the alarms, and the alarm-related information acquisition section selects brief information on a selected alarm, and selects sequential information leading to generation of the alarm from information stored as the process history in the information storage section in association with the brief information.

4. The process system according to claim 3, wherein the alarm-related information acquisition section selects I/O information around generation of an alarm corresponding to the sequential information leading to generation of the alarm from information stored as the process history in the information storage section.

5. The process system according to claim 4, wherein the display section can display a first screen which displays the brief information on the selected alarm, a second screen which displays sequential information leading to generation of an alarm, and a third screen which displays I/O information around generation of an alarm.

6. The process system according to claim 3, wherein the brief information stored in the information storage section according to the each alarm includes an ID of the alarm, contents of the alarm, one or two or more possible reasons for generation, and actions against individual reasons for generation.

7. A process system comprising:
a process apparatus which performs a predetermined process on an object to be processed;
a plurality of detection means which detect statuses in the process apparatus;
an abnormality detection section which detects an abnormality in detection information from the plurality of detection means;
an alarm generation section which generates an alarm when the abnormality detection section detects an abnormality;
an information storage section which stores the detection information from the detection means and alarm information as a process history of the process apparatus and prestores an alarm table describing brief information according to individual alarms and linkable to the process history;
an alarm-related information acquisition section which selects brief information on an alarm selected from the alarm table in the information storage section and acquires, as link information, sequential information leading to generation of the selected alarm from information stored as the process history in the information storage section; and
a display section which displays alarm-related information acquired by the alarm-related information acquisition section.

8. The process system according to claim 7, wherein the alarm-related information acquisition section selects I/O information around generation of an alarm corresponding to the sequential information leading to generation of the alarm.

9. The process system according to claim 8, wherein the display section can display a first screen which displays the brief information on the selected alarm, a second screen which displays sequential information leading to generation of an alarm, and a third screen which displays I/O information around generation of an alarm.

10. The process system according to claim 7, wherein the brief information stored in the information storage section according to the each alarm includes an ID of the alarm, contents of the alarm, one or two or more possible reasons for generation, and actions against individual reasons for generation.

11. A process system comprising:
a plurality of process apparatuses which perform a predetermined process on an object to be processed;
an apparatus control unit which controls the plurality of process apparatuses based on information to be detected in the process apparatuses, detects an abnormality when the information to be detected in the process apparatuses is off a predetermined range, and generates an alarm when the abnormality detection section detects an abnormality; and
a control apparatus which receives all or nearly all process information from the process apparatuses, and controls the process apparatuses based on the process information, and which includes
an information storage section which stores the process information and alarm information received from the process apparatuses as process histories of the process apparatuses,
an alarm-related information acquisition section which acquires information relating to an alarm selected from generated alarms from the information storage section, and
a display section which displays alarm-related information acquired by the alarm-related information acquisition section.

12. A process system comprising:
a plurality of process apparatuses which perform a predetermined process on an object to be processed;
an apparatus control unit which controls the plurality of process apparatuses based on information to be detected in the process apparatuses, detects an abnormality when the information to be detected in the process apparatuses is off a predetermined range, and generates an alarm when the abnormality detection section detects an abnormality; and
a control apparatus which receives all or nearly all process information from the process apparatuses, and controls the process apparatuses based on the process information, and which includes
an information storage section which stores the process information and alarm information received from the process apparatuses as process histories of the process apparatuses, and prestores an alarm table describing brief information according to individual alarms and linkable to the process history,
an alarm-related information acquisition section which selects brief information on an alarm selected from the alarm table in the information storage section and acquires, as link information, sequential information leading to generation of the selected alarm from information stored as the process histories in the information storage section, and
a display section which displays alarm-related information acquired by the alarm-related information acquisition section.

13. A process method comprising: storing detection information from a plurality of detection means provided in a process apparatus, which performs a predetermined process on an object to be processed, and information on alarms to be generated when detecting an abnormality in the detection information from the plurality of detection means, as a process history in an information storage section; acquiring information relating to an alarm selected from the generated alarms from the information storage section; and displaying alarm-related information acquired.

14. The process method according to claim 13, wherein the alarm-related information includes I/O address information relating to the alarm.

15. The process method according to claim 13, wherein the information storage section prestores brief information on alarms according to types of the alarms, selects brief information on a selected alarm, and selects sequential information leading to generation of the alarm from information stored as the process history in the information storage section in association with the brief information.

16. The process method according to claim 15, wherein acquisition of the alarm-related information is carried out by selecting I/O information around generation of an alarm corresponding to the sequential information leading to generation of the alarm from information stored as the process history in the information storage section.

17. The process method according to claim 16, wherein the alarm-related information is displayed on one of a first screen which displays the brief information on the selected alarm, a second screen which displays sequential information leading to generation of an alarm, and a third screen which displays I/O information around generation of an alarm.

18. A process method comprising: storing detection information from a plurality of detection means provided in a process apparatus, which performs a predetermined process on an object to be processed, and information on alarms to be generated when detecting an abnormality in the detection information from the plurality of detection means, as a process history in an information storage section; prestoring an alarm table describing brief information according to individual alarms and linkable to the process history; selecting brief information on an alarm selected from the alarm table in the information storage section; acquiring, as link information, sequential information leading to generation of the selected alarm from information stored as the process history in the information storage section; and displaying information selected from the alarm table and the acquired sequential information leading to generation of the selected alarm.

19. The process method according to claim 18, wherein acquisition of the alarm-related information is carried out by acquiring I/O information around generation of an alarm corresponding to the sequential information leading to generation of the alarm from information stored as the process history in the information storage section.

20. The process method according to claim 19, wherein the display is done on one of a first screen which displays the brief information on the selected alarm, a second screen which displays sequential information leading to generation of an alarm, and a third screen which displays I/O information around generation of an alarm.

21. The process method according to claim 15, wherein the brief information stored in the information storage section according to the each alarm includes an ID of the alarm, contents of the alarm, one or two or more possible reasons for generation, and actions against individual reasons for generation.

22. A computer readable storage medium containing software that allows a computer to perform control in a way which comprises storing detection information from a plurality of detection means provided in a process apparatus, which performs a predetermined process on an object to be processed, and information on alarms to be generated when detecting an abnormality in the detection information from the plurality of detection means, as a process history in an information storage section, acquiring information relating to an alarm selected from the generated alarms from the information storage section, and displaying alarm-related information acquired.

23. A computer readable storage medium containing software that allows a computer to perform control in a way which comprises storing detection information from a plurality of detection means provided in a process apparatus, which performs a predetermined process on an object to be processed, and information on alarms to be generated when detecting an abnormality in the detection information from the plurality of detection means, as a process history in an information storage section, prestoring an alarm table describing brief information according to individual alarms and linkable to the process history, selecting brief information on an alarm selected from the alarm table in the information storage section, acquiring, as link information, sequential information leading to generation of the selected alarm from information stored as the process history in the information storage section, and displaying information selected from the alarm table and the acquired sequential information leading to generation of the selected alarm.

24. A computer program containing software that allows a computer to perform control in a way which comprises storing detection information from a plurality of detection means provided in a process apparatus, which performs a predetermined process on an object to be processed, and information on alarms to be generated when detecting an abnormality in the detection information from the plurality of detection means, as a process history in an information storage section, acquiring information relating to an alarm selected from the generated alarms from the information storage section, and displaying alarm-related information acquired.

25. A computer program containing software that allows a computer to perform control in a way which comprises storing detection information from a plurality of detection means provided in a process apparatus, which performs a predetermined process on an object to be processed, and information on alarms to be generated when detecting an abnormality in the detection information from the plurality of detection means, as a process history in an information storage section, prestoring an alarm table describing brief information according to individual alarms and linkable to the process history, select brief information on an alarm selected from the alarm table in the information storage section, acquiring, as link information, sequential information leading to generation of the selected alarm from information stored as the process history in the information storage section, and displaying information selected from the alarm table and the acquired sequential information leading to generation of the selected alarm.
